(19) United States
(12) Patent Application Publication
(10) Pub. No.: US 2004/0042594 A1
(43) Pub. Date: Mar. 4, 2004

(54) Telephone unit and method of transmitting the received information about callers

(76) Inventors: Toshihiko Sakata, Fukuoka (JP); Junichi Maehara, Fukuoka (JP); Noriaki Fukuoka, Fukuoka (JP); Shinji Ikegami, Fukuoka (JP); Naohiro Nagano, Fukuoka (JP); Masaomi Kondo, Fukuoka (JP)

Correspondence Address: LAWRENCE E. ASHERY, SUITE 301, ONE WESTLAKES, BERWYN, P.O. BOX 980, VALLEY FORGE, PA, 19482-0980, US

(21) Appl. No.: 10/460,831

(22) Filed: Jun. 12, 2003

(30) Foreign Application Priority Data
Jun. 13, 2002 (JP) 2002-172309

(51) Int. Cl. H04M 1/64; H04M 3/42

(52) U.S. Cl. 379/88.19; 379/207.15

(57) ABSTRACT

When a telephone unit in the present invention receives a caller data at incoming call, it provides a new history data or updates a existing history data for storage in memory unit; depending on situation whether or not there exists a history data containing caller's telephone number and incoming date and time indicated in the caller data. It has a caller data voice transmittance processor which transmits via voice processor the stored history data to outside, in response to a reproduction command. Under the above-described configuration, the telephone unit can transmit the caller-related information to the user away from home; either for the entire information, for the latest information alone, or for the whole information received from a certain specific caller, upon optional demand of the user.

### TECHNICAL FIELD

The present invention relates to a telephone unit which can transmit upon request the caller-related information including caller data stored in a memory to, for example, a user of the telephone unit away from home. Method of transmitting is also disclosed in the invention.

### BACKGROUND ART

Functions of the recent janitor telephones (message recording telephone) have become sophisticated. For example, some of such telephone units can provide a user away from home with the incoming telephone numbers and messages of callers in the form of voice message.

FIG. 15A and FIG. 15B show the structure of a conventional massage-recording telephone system. Telephone unit 221 installed at home is connected with other party's telephone unit 223 via telephone network 222. It is also connected with other telephone unit 224 of the user such as portable telephone or the like.

Referring to FIG. 15A, when telephone unit 221 gets a call from other party's telephone unit 223, it receives caller data 231 which indicate telephone number of the other party's telephone unit 223 and incoming date and time, as well as the message. A memory unit (not shown) of telephone unit 221 records caller data 231 in the form of history data representing call record from caller, while the received message in the form of recorded data. Information containing these history data and recorded data is referred to as caller-related information.

Referring to FIG. 15B, the user away from home transmits demand signal 232 using telephone unit 224 requesting telephone unit 221 to send contents of received calls. Telephone unit 221 transmits caller-related information 233 stored in the memory unit to telephone unit 224. In this way, the user away from home can receive caller-related information 233, and be informed of the contents in the form of voice message, or through other means. The caller-related information thus accessible to the user from outside, or by direct operation of telephone unit 221, is an old information, while the caller-related information that the user has not been informed of is a new information.

As described in the above, conventional massage-recording telephone unit can transmit the received caller-related information including caller's telephone number, message, etc. to a user away from home. However, such function of conventional telephone unit is to simply transmit the caller-related information accumulated in the telephone unit through incoming. In other words, the conventional telephone unit is not capable of selectively transmitting the caller-related information, or collectively transmitting only those received from a certain specific caller.

### SUMMARY OF THE INVENTION

In a telephone unit of the present invention, when a call is received and caller data is delivered, and a history data containing caller's telephone number and incoming date and time that correspond to indications in the caller data is existing, the telephone unit updates the history data and stores it. The telephone unit has a caller data voice transmittance processor which transmits, in accordance with a reproduction command, the stored history data to outside via a voice processor. A transmitting method in the present invention includes the steps of determining whether or not a caller data is received, storing a history data containing caller data, updating a history data of caller if there is the one which is indicated in the caller data, reading a caller data stored in memory and outputting it, receiving a reproduction command from outside, and transmitting the updated history data to outside.

### BRIEF DESCRIPTION OF THE DRAWINGS

FIG. 1A, FIG. 1B are structures of a massage-recording telephone system in accordance with an exemplary embodiment of the present invention.

FIG. 2 is a block diagram of a telephone unit in accordance with an exemplary embodiment of the present invention.

FIG. 3 is a function block diagram of a main controller in the telephone unit.

FIG. 4 is a flow chart showing the operation of the main controller in the telephone unit.

FIG. 5 is a function block diagram of a bell counts processor in the telephone unit.

FIG. 6 is a flow chart showing the operation of the bell counts processor in the telephone unit.

FIG. 7 is a function block diagram of a caller data reception processor in the telephone unit.

FIG. 8 is a flow chart showing the operation of the caller data receiving and processing unit in a telephone unit in accordance with an exemplary embodiment of the present invention.

FIG. 9 is a function block diagram of a network monitor processor in the telephone unit.

FIG. 10 is a flow chart showing the operation of the network monitor processor in the telephone unit.

FIG. 11 is a function block diagram of a caller data voice transmittance processor in the telephone unit.

FIG. 12 is a flow chart showing the operation of the caller data voice transmittance processor in the telephone unit.

FIG. 13 is a function block diagram of a speech transmittance processor in the telephone unit.

FIG. 14 is a flow chart showing the operation of the speech transmittance processor in the telephone unit.

FIG. 15A, FIG. 15B are structures of a conventional massage-recording telephone system.

### DETAILED DESCRIPTION OF PREFERRED EMBODIMENT

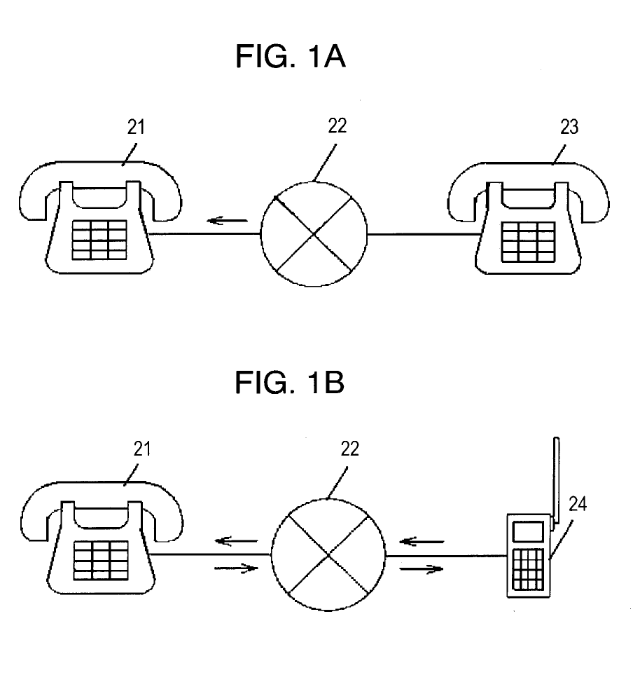

FIG. 1A, FIG. 1B show the structures of a massage-recording telephone system in accordance with an exemplary embodiment of the present invention. Telephone unit 21 at a user's home is connected to other party's telephone unit 23 via telephone network 22. It is also connected to other telephone unit 24, e.g. a portable telephone unit.

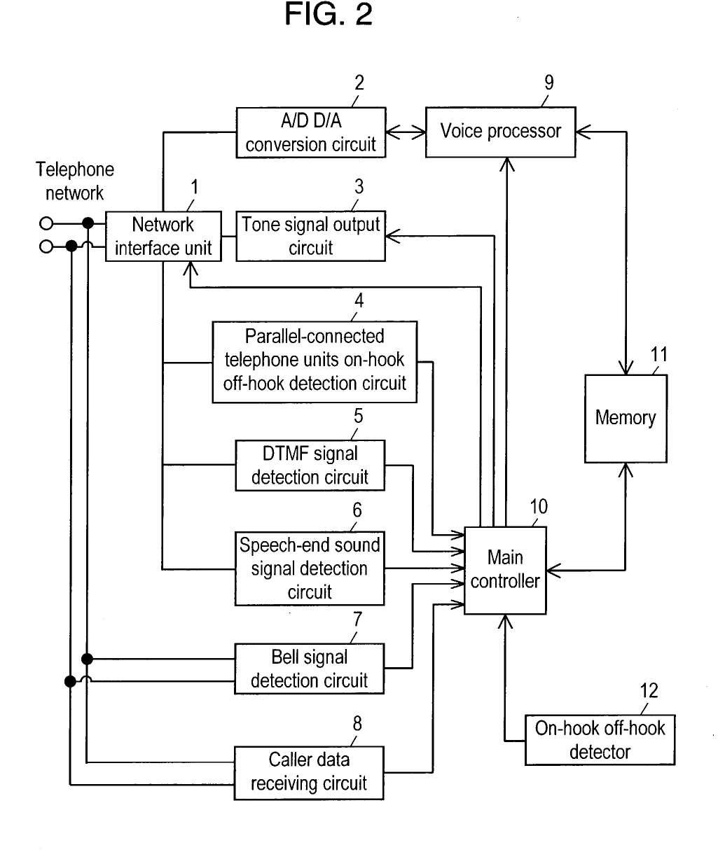

FIG. 2 shows a block diagram of a telephone unit in accordance with an exemplary embodiment of the present invention. Network interface unit (hereinafter referred to as interface) 1 controls the closure and the opening of telephone network. A/D D/A conversion circuit (conversion circuit) 2 converts analog signal to digital signal, and vice versa. Tone signal output circuit (output circuit) 3 transmits beep sound representing the start of recording. Parallel-connected telephone units on-hook off-hook detection circuit (detection circuit) 4 detects the on-hook or off-hook state at the parallel-connected telephone units. Dial Tone Multi Frequency(DTMF) signal detection circuit (detection circuit) 5 detects the DTMF signal including password and reproduction command. Speech-end sound detection circuit (detection circuit) 6 detects the speech-end sound at telephone network. Bell signal detection circuit (detection circuit) 7 detects bell signal at telephone network. Caller data receiving circuit (receiving circuit) 8 receives caller data delivered when a call is made. The caller data includes telephone number, caller's name, date and time, etc. Voice processor 9 compresses the digitalized voice signal (digital voice data), and stores it in memory 11 as compressed voice data. Processor 9 decompresses the compressed voice data stored in memory 11 and delivers it to conversion circuit 2. Processor 9 converts the text data stored as caller data into speech data, and delivers it to conversion circuit 2. Main controller (controller) 10 controls relevant circuits and judges the conditions of them. Memory 11 stores, as described earlier, the compressed voice data, the speech data, the caller data, etc. On-hook off-hook detector (detector) 12 notifies controller 10 that a talk button, or a speaker phone button, is pressed, or a handset is lifted up.

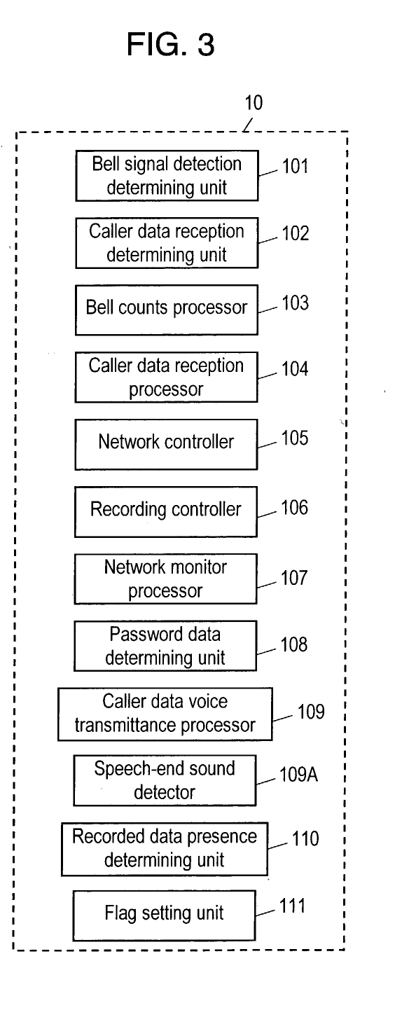

FIG. 3 shows a function block diagram of controller 10 implemented in accordance with a program. Bell signal detection determining unit (determining unit) 101 determines whether a bell signal is detected at detection circuit 7 or not. Caller data reception determining unit (determining unit) 102 determines whether a caller data is received at receiving circuit 8 or not. Bell counts processor (processor) 103 counts number of bell ringing. Caller data reception processor (processor) 104 processes the caller data received. Network controller (controller) 105 controls the telephone network. Recording controller (controller) 106 controls things related to recording. Network monitor processor (processor) 107 monitors the telephone network. Password data determining unit (determining unit) 108 determines whether a password is received or not, and judges whether the password is correct or not. Caller data voice transmittance processor (processor) 109 processes caller data to be transmitted in the form of voice. Speech-end sound detector (detector) 109A detects a speech-end sound. Recorded data presence determining unit (determining unit) 110 determines whether there exists a recorded data or not. Flag setting unit (setting unit) 111 sets up various kinds of flags.

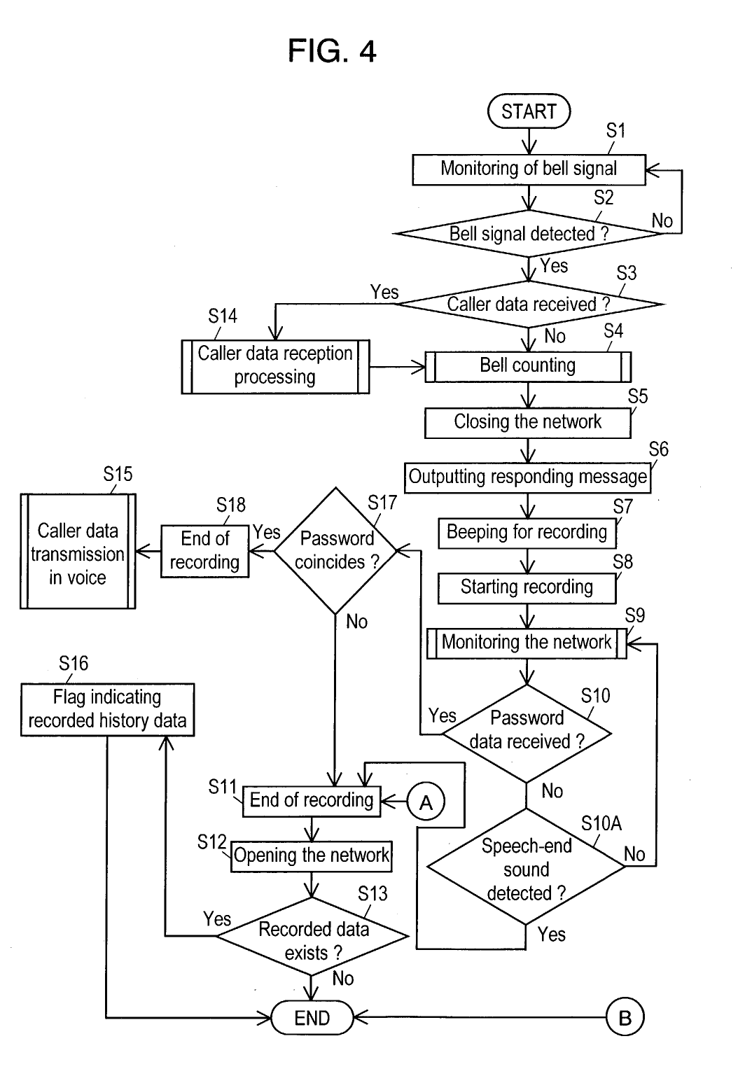

Operation of the above-configured controller 10 is described with reference to FIG. 4, hereinafter. Determining unit 101 monitors bell signal at the telephone network (S1). And it determines whether bell signal is detected or not, based on notice delivered from detection circuit 7 (S2). The bell signal is generated by, for example, telephone unit 24 operated by the user away from home, ref FIG. 1B. If a bell signal is determined to have been detected, determining unit 102 determines whether caller data is received or not (S3). If it is determined that no caller data was received, processor 103 counts the number of bells. When the bell counts reached a predetermined number the processing shifts to S5 (S4). If caller data is determined to have been received at S3, processor 104 provides a new history data, or updates an existing one (S14). When the caller data reception processing is finished, the processing shifts to S4.

At S5, controller 105 controls interface 1 to close the telephone network. Controller 106 outputs a responding message and a beep sound representing the start of recording to, for example, the user's telephone unit 24 away from home via telephone network (S6, S7), and begins recording (S8). Conversion circuit 2 converts voices from telephone network into digital voice data, voice processor 9 converts it into compressed voice data. Memory 11 stores compressed voice data. The recording is made in this way. Next, processor 107 monitors network (S9). At the network monitoring, DTMF signal is monitored; in a case where no off-hook state is detected, neither in the parallel telephone units, the processing shifts to S10. If a parallel telephone unit is determined to be in off-hook state, the network monitoring is terminated and the process shifts to S1.

At S10, determining unit 108 determines whether a password data is received or not. If a password data is determined to have been received, determining unit 108 determines whether the password coincides with a specific password (e.g. the user's password) or not (S17). If the password is determined to be in coincidence, controller 106 terminates the recording operation (S18), and processor 109 transmits the caller data in the form of voice (S15). If it is determined that no password is received at S10, detector 109A determines whether an end-speech sound is detected or not (S10A); if a speech-end sound is determined to have been detected, controller 106 terminates the recording operation (S11). If it is determined that no speech-end sound is detected, the processing returns to S9. In a case if the password is determined not to be in coincidence at S17, controller 106 terminates the recording operation, also in this case (S11). Next, controller 105 puts the telephone network in open state (S12). And then, determining unit 110 determines whether there exists recorded data in memory unit 11 or not (S13). If there is a recorded data, setting unit 111 sets up a flag telling that there is a recorded history data received (S16), and the main processing is finished. On the other hand, if there is no recorded data, no such a flag is set up, and the main processing is finished.

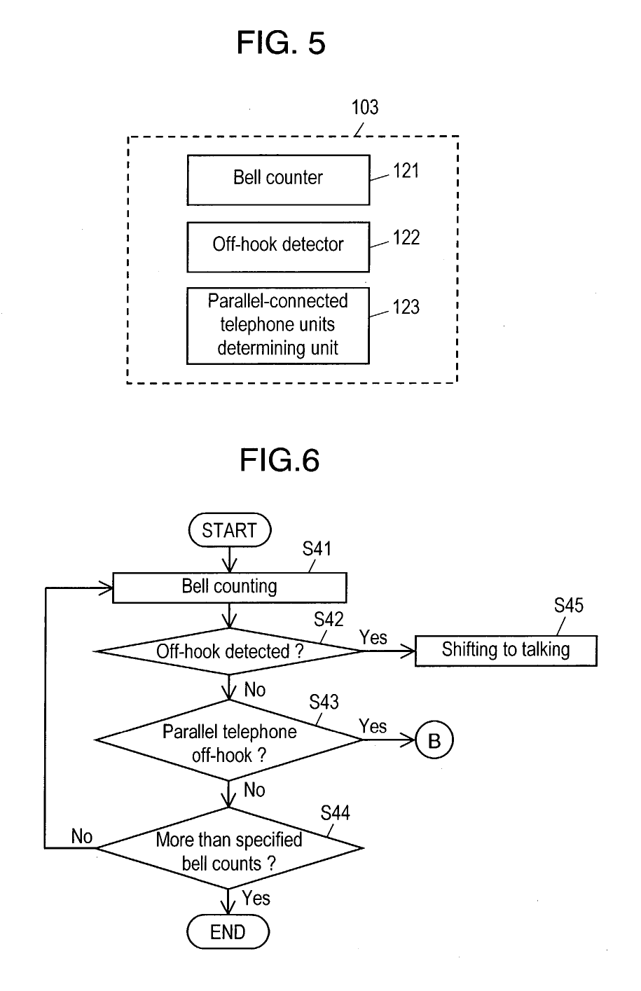

FIG. 5 is a function block diagram showing processor 103, which is the principal operating member at S4. Bell counter (counter) 121 counts the number of bell ringing based on notice delivered from detection circuit 7. Off-hook detector (detector) 122 determines whether an off-hook is detected or not, based on notice delivered from detector 12. Parallel-connected telephone units determining unit (determining unit) 123 determines whether there is on-hook or off-hook state among the parallel-connected telephone units (not shown), based on notice delivered from detection circuit 4. The on-hook or off-hook state means whether a telephone unit among the parallel-connected units is in the state where the receiver of which is lifted up or not.

Operation of the above-configured processor 103 is described referring to FIG. 6. Counter 121 counts number of bell ringing (S41). Detecting unit 122 determines whether off-hook state is detected or not (S42); if off-hook state is determined to have been detected, the processing shifts to talking state (S45). If it is determined that no off-hook state is detected, determining unit 123 determines whether a parallel-connected telephone unit is in off-hook state or not (S43). If it is determined that there is off-hook state, the main processing is terminated, and the bell counting process is also finished. If it is determined that there is no off-hook state among parallel-connected telephone units, counter 121 determines whether the number of bell ringing is in excess of a predetermined number (e.g. five) or not (S44). If it is determined that the number exceeded the predetermined number, the bell counting process is terminated and the processing shifts to S5; if it is determined that the number is not more than the predetermined number, it returns to S41.

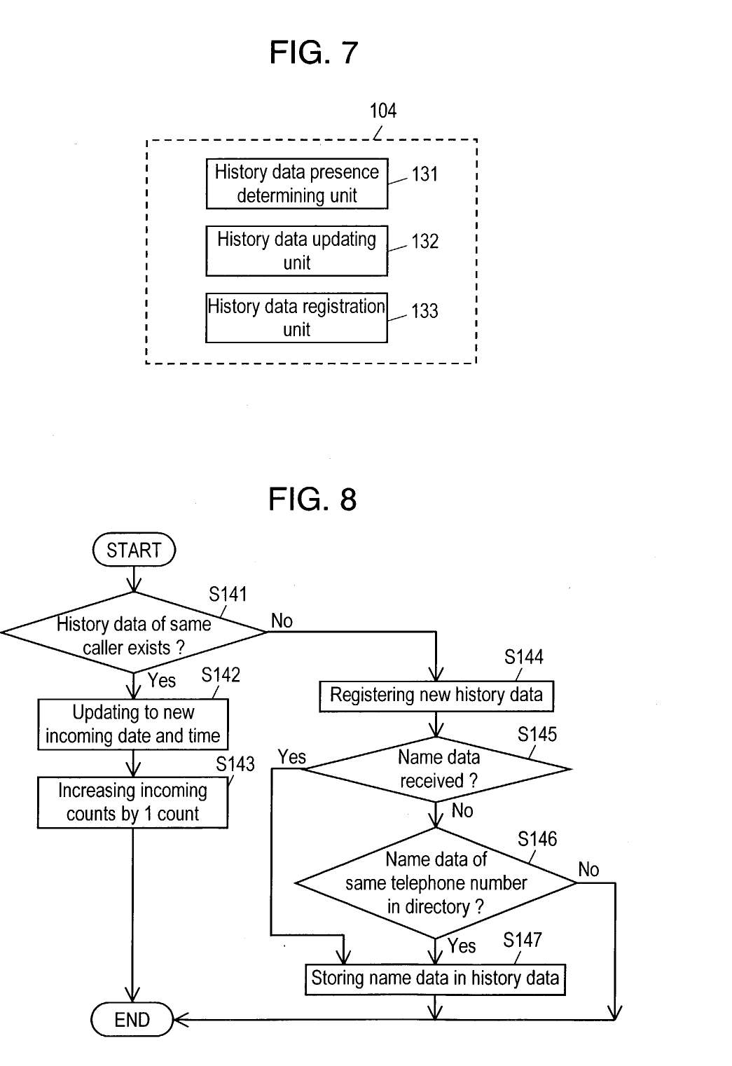

FIG. 7 is a function block diagram of processor 104, which is the principal operating member at S14. History data presence determining unit (determining unit) 131 determines whether there exists a history data or not. History data updating unit (updating unit) 132 updates history data. History data registration unit (registration unit) 133 registers a new history data.

Operation of the above-configured processor 104 is described with reference to FIG. 8. Determining unit 131 determines whether there exists a history data pertaining to the caller indicated by the received caller data or not (S141). If determining unit 131 determined that there exists the history data, updating unit 132 updates the history data in the date and time received (incoming date and time) (S142), and number of incoming history data is counted up by one count (S143). History data contains the caller's telephone number, the caller's name, presence or non-presence of recorded data, etc as well as the above-described incoming date and time and the number of incoming data. If determining unit 131 determines that there is no history data pertaining to the same caller at S141, registration unit 133 registers a new history data (a newly received history data) (S144), and determines whether there is name data contained in the received caller data or not (S145). If it is determined that there exists a name, the name data is stored in the new history data (S147), and the caller data reception processing is finished, and the processing shifts to S4. If there is no name data in the received caller data, a telephone directory (not shown) stored in memory 11 is searched for a name data that corresponds to the telephone number indicated in the received caller data (S146). When a name data corresponding to the telephone number is found in the telephone directory, the name data is stored in the new history data (S147); if there is no name data, the caller data reception processing is terminated, and the processing shifts to S4. Steps S145 through S147 indicate operation for coordinating the name data.

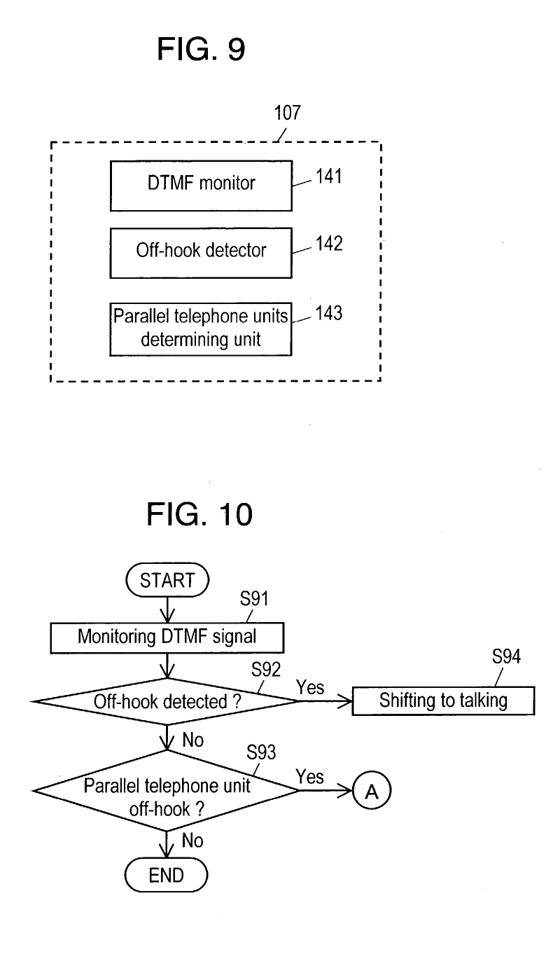

FIG. 9 is a function block diagram of processor 107, which is the principal operating member at S9. DTMF monitor (monitor) 141 monitors DTMF signal. Off-hook detector (detector) 142 determines whether an off-hook state is detected or not based on notice from detector 12. Parallel telephone units determining unit (determining unit) 143 determines the on-hook or off-hook state among the parallel-connected telephone units, based on notice from detection circuit 4.

Operation of the above-configured processor 107 is described referring to FIG. 10. Monitor 141 monitors the DTMF signal (S91). And then, detector 142 determines whether an off-hook state is detected or not (S92). If it is determined that an off-hook state is detected, the processing shifts to talking state (S94). If it is determined that no off-hook state is detected, determining unit 143 determines whether a parallel-connected telephone unit is in off-hook state or not (S93); if it is determined that there is an off-hook state, the network monitoring process is terminated, and the processing shifts S11 in the main processing. If it is determined that there is no off-hook state among the parallel-connected telephone units, the network monitoring process is terminated, and the processing shifts to S10 in the main processing.

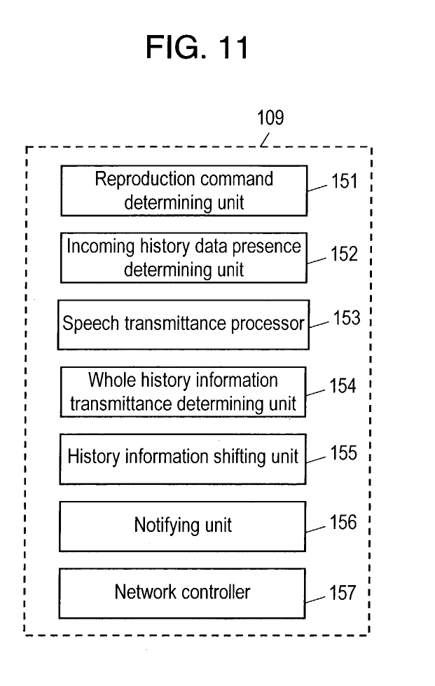

FIG. 11 is a function block diagram of processor 109, which is the principal operating member at S15. Reproduction command determining unit (determining unit) 151 determines contents of a reproduction command. Incoming history data presence determining unit (determining unit) 152 determines whether there is incoming history data (received history data) or not. Speech transmittance processor (processor) 153 transmits a speech (notifying voice signal). Whole history information transmittance determining unit (determining unit) 154 determines whether all of the relevant history information has been transmitted or not. History information shifting unit (shifting unit) 155 transfers the transmitting history information to next history information. When there is no incoming history data, notifying unit 156 notifies accordingly. Network controller (controller) 157 controls opening/closing of telephone network.

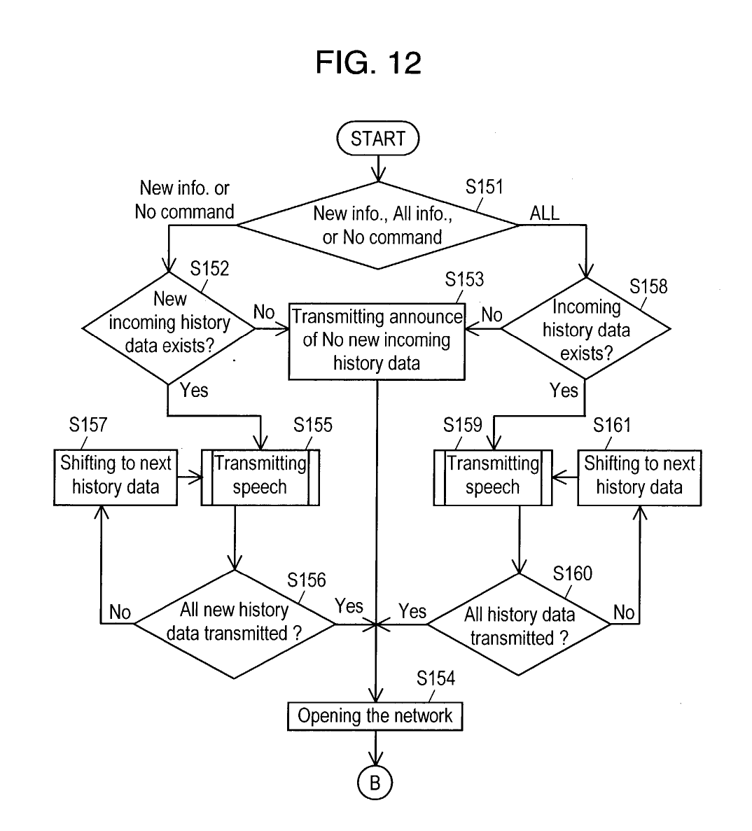

Operation of the above-configured processor 109 is described referring to FIG. 12. Determining unit 151 determines whether the contents of a reproduction command is opting for the all caller-related information or for the new caller-related information (S151). If it is determined that the command is opting for the new caller-related information, or it is determined that there is no reproduction command received, then determining unit 152 determines whether there is a new incoming history data or not (S152). If it is determined that there is no new incoming history data, notifying unit 156 sends a notice telling that no new incoming history data exists to, for example, telephone unit 24 of the user, via interface 1 and telephone network 22 (S153). Controller 157 turns the telephone network into open state (S154). If it is determined that there is a new incoming history data at S152, processor 153 transmits a speech (S155). And then, determining unit 154 determines whether all of the latest history data has been transmitted or not (S156). If it is determined that they have been transmitted, controller 157 turns the telephone network into open state (S154); if determined otherwise, shifting unit 155 shifts to the next history information (S157), and the processing shifts to S155.

If it is determined that all of the caller-related information is opted for at S151, determining unit 152 determines whether there exists incoming history data or not (S158). If it is determined that there is no incoming history data, notifying unit 156 sends a notice telling that no new incoming history data exists to, for example, telephone unit 24 of the user, via interface 1 and telephone network 22 (S153). Controller 157 turns the telephone network into open state (S154). If it is determined that there is an incoming history data at S158, processor 153 transmits a speech (S159). And then, determining unit 154 determines whether all of the history data have been transmitted or not (S160). If it is determined that they have been transmitted, controller 157 turns the telephone network into open state (S154); if determined otherwise, shifting unit 155 shifts to the next history information (S161), and the processing shifts to S159. When new incoming history has been transmitted, setting unit 111 sets up a flag indicating that it has been transmitted, in order that it will not be transmitted as new incoming history at the subsequent transmittance of incoming history.

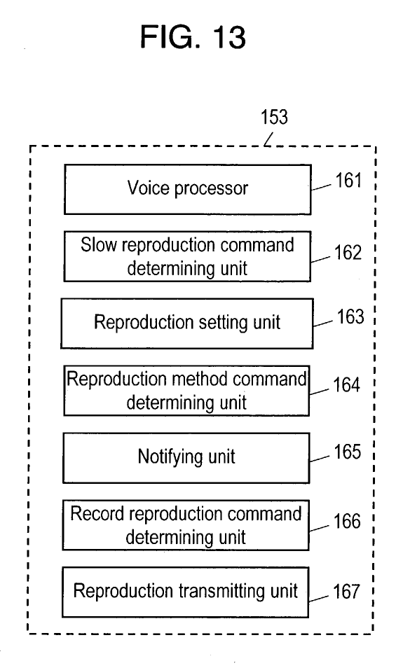

FIG. 13 is a function block diagram of processor 153 that is the principal operating member at S155 and S159. Voice processor 161 converts caller data (text data) into speech data at voice processor 9, and the speech data into analog voice signal at conversion circuit 2. Slow reproduction command determining unit (determining unit) 162 determines whether slow reproduction command is received or not. Reproduction setting unit (setting unit) 163 specifies the slow reproduction. Reproduction method command determining unit (determining unit) 164 determines whether a command indicating a method of reproduction (reproduction method command) is received or not. Notifying unit 165 notifies whether or not there exists a recorded message. Record reproduction command determining unit (determining unit) 166 determines whether a record reproduction command is received or not. Reproduction transmitting unit 167 reproduces the recorded message and transmits it.

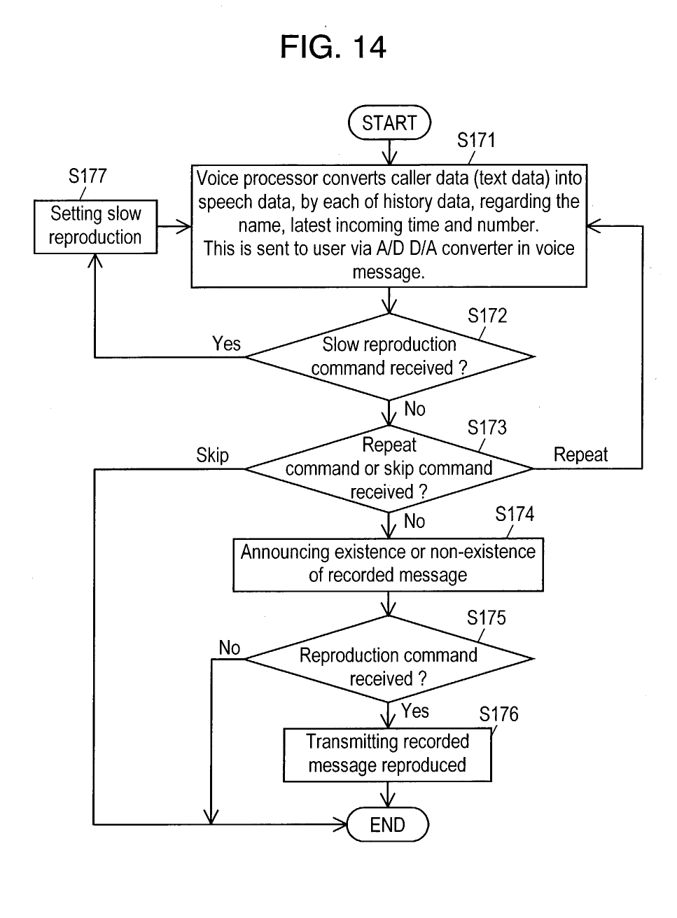

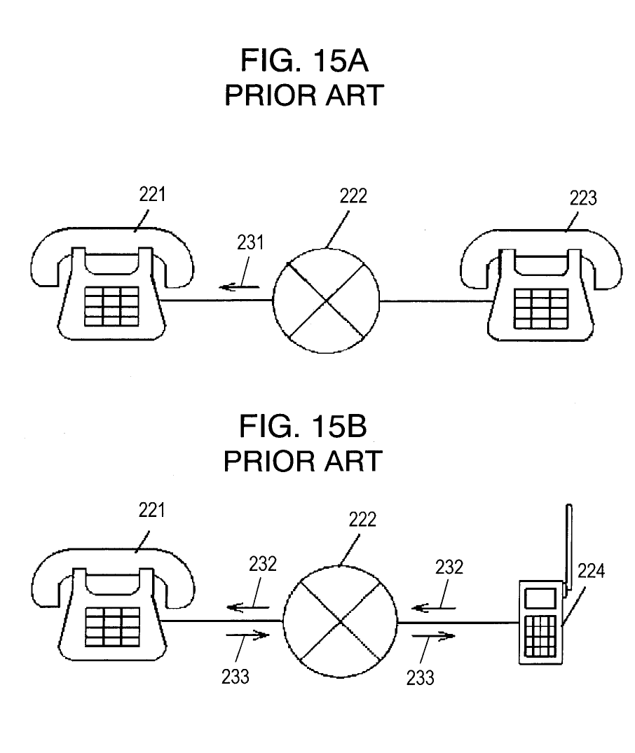

Operation of the above-configured speech transmittance processor 153 is described referring to FIG. 14. Voice processor 161 converts the caller data into speech data (digital voice data) at voice processor 9. Further at conversion circuit 2, the speech data is converted into analog voice signal (S171). Determining unit 162 determines whether a slow reproduction command is received or not (S172). When a slow reproduction command is determined to have been received, setting unit 163 sets the slow reproduction (S177). When slow reproduction finishes, determining unit 164 determines whether a repeat command is received or a skip command is received (S173). When a repeat command is determined to have been received, it returns to S171. When repeat operation finishes, notifying unit 165 sends a message to, for example, telephone unit 24 of the user, as to whether or not there is a recorded message (S174). Determining unit 166 determines whether a record reproduction command is received or not (S175). When it is determined to have been received, reproduction transmitting unit 167 reproduces recorded message and transmits it to, for example, telephone unit 24 of the user (S176). If it is determined that a skip command is received at S173, or it is determined that no record reproduction command is received at S175, the speech transmitting processing is terminated, and the processing shifts to S156 or S160.

As described above, main controller 10 in a telephone unit in the present embodiment has caller data reception determining unit 102, caller data reception processor 104, and caller data voice transmittance processor 109. Determining unit 102 determines whether a caller data is received or not. When a caller data is determined to have been received, and there exists a history data containing the same caller's telephone number, incoming date and time indicated in the received caller data, processor 104 updates the history data and have it stored in memory 11. Upon request from the user away from home, processor 109 transmits the history data stored in memory 11 via voice processor 9. Processor 9 reads caller data out of memory 11, and outputs it to network interface unit 1. A telephone unit having the above-described structure can transmit, in response to request of the user away from home, either the entire caller-related information including old and new, the latest caller-related information alone, or the whole set of caller-related information received from a specific caller.

If there exists no such history data, processor 109 generates a new history data. Thus, history data including incoming of caller data can be provided automatically.

A telephone unit in the present embodiment further has password data determining unit 108. Determining unit 108 determines whether or not a password received from outside after closure of network coincides with a specific password. When the password is determined to have coincidence with the specific password, processor 109 transmits history data in accordance with the contents of reproduction command to outside via processor 9. In this way, a caller data can not be tapped out easily by undue access makers; thus, the confidentiality of caller data is protected to a certain extent.

Furthermore, determining unit 102 has history data presence determining unit 131 and history data updating unit 132. Determining unit 131 determines whether there exists a history data pertaining the caller indicated in the caller data or not. When it is determined that history data exists, updating unit 132 updates the history data in the date and time to the latest, and counts up the number of incoming history data by one count. Under the above-described structure, the history data can be appropriately updated.

Determining unit 102 further has history data registration unit 133. If it is determined that there exists no history data, registration unit 133 registers a new history data. Under the above described-structure, history data can be duly provided, if there exists no history data.

Furthermore, when name data is contained in caller data, registration unit 133 registers the name data in the history data. Thus, when a name data is contained caller data, it is surely registered in the history data. In a case where there is no name data contained in caller data but the same telephone number as that indicated in caller data is seen in a telephone directory stored in memory 11, registration unit 133 registers the name data corresponding to the telephone number in the history data. In this way, when a name data is registered in telephone directory it can be registered in history data without fail. Thus, when caller-related information is transmitted to the user away from home, he or she can be informed of caller's name without fail.

Furthermore, processor 109 has speech transmittance processor 153. Processor 153 transmits history data stored in memory 11 to outside via processor 9, as analog voice signal. Thus, the user can be informed of history data corresponding to a reproduction command, in the form of voice.

Furthermore, processor 153 has reproduction setting unit 163, which reads out history data slow from memory 11 if reproduction command received specifies a slow reproduction. Thereby, when a slow reproduction is specified by the reproduction command received, recorded data is surely reproduced slow, and the slow-reproduced voice signal is transmitted to the user away from home. Therefore, the user can understand the message without fail.

Furthermore, processor 153 has reproduction method command determining unit 164, which determines whether a repeat command is received or not. When it is determined that a repeat command is received, the voice message is reproduced repeatedly. Therefore, the user can hear surely and understand the voice message without fail. Determining unit 164 may be designed so that it can determine whether a skip command is received or not. When it is determined that a skip command is received, the voice message reproduction is skipped. Thereby, reproduction processing can be terminated immediately upon the skip command, and the processing can be expedited.

Furthermore, main controller 10 in the telephone unit has recorded data presence determining unit 110 and flag setting unit 111. Determining unit 110 determines whether there is a recorded data in memory 11. Flag setting unit 111 sets, when it is determined that there is a recorded data, a flag indicating the presence of recorded history data. Under the above-described configuration, the user can be informed of the existence, or non-existence, of recorded message surely and quickly. Thus the user can have reproduced voice message immediately.

What is claimed is:

1. A telephone unit comprising
a bell signal detection circuit for detecting bell signal;
a network interface unit for connection with telephone network;
a caller data reception determining unit for determining whether a caller data is received or not, which the caller data containing at least caller's telephone number and incoming date and time;
a memory for storing a history data containing at least the caller data;
a caller data reception processor, which updates the history data and has the history data stored in said memory, when it is determined that a caller data is received;
a voice processor, which reads the caller data out of said memory; and
a caller data voice transmittance processor for transmitting the history data stored in said memory to the outside via said voice processor, in accordance with contents of a reproduction command received from outside.

2. The telephone unit of claim 1, wherein
said caller data voice transmittance processor transmits either one of the entire history data stored in said memory unit and the new history data alone, in accordance with the reproduction command.

3. The telephone unit of claim 1, wherein
said caller data reception processor provides a new history data if there exists no history data of a caller indicated in the caller data.

4. The telephone unit of claim 1, further comprising
a password data determining unit for determining whether a password received from outside coincides with a certain specific password or not, wherein
said caller data voice transmittance processor transmits the history data when the received password is determined to be in coincidence with the specific password.

5. The telephone unit of claim 1, wherein the history data further contains incoming counts received from a caller; wherein
said caller data reception processor further includes
a history data presence determining unit for determining whether there exists a history data of the caller indicated in the caller data or not; and
a history data updating unit for updating the history data in the incoming date and time to the latest, and increases the incoming counts of the history data for one count, when said history data presence determining unit determines that there exists a history data of the caller indicated in the caller data.

6. The telephone unit of claim 5, further comprising
a history data registration unit for registering a new history data when said history data presence determining unit determines that there is no history data of the caller indicated in the caller data.

7. The telephone unit of claim 6, wherein
the caller data and the history data further contain a name data regarding the caller's name, and said history data registration unit registers the name data contained in the received caller data in the new history data.

8. The telephone unit of claim 1, wherein the history data further contains a name data regarding the caller's name, further comprising
a history data registration for registering the name data corresponding to the same telephone number in the history data, when said memory stores the same telephone number as indicated in the caller data.

9. The telephone unit of claim 1, wherein
said caller data voice transmittance processor transmits the history data to outside in a form of analog voice signal.

10. The telephone unit of claim 1, wherein
said caller data voice transmittance processor transmits the history data slow when the reproduction command contains a slow reproduction command.

11. The telephone unit of claim 1, wherein
said caller data voice transmittance processor includes a reproduction method command determining unit for determining whether a repeat command is received or not, and repeats reproduction of voice message as indicated by the reproduction command, when said reproduction method command determining unit determined that a repeat command was received.

12. The telephone unit of claim 1, wherein
said caller data voice transmittance processor includes a reproduction method command determining unit for determining whether a skip command is received or not, and skips reproduction of voice message as indicated by the reproduction command, when said reproduction method command determining unit determined that a skip command was received.

13. The telephone unit of claim 1, wherein said memory stores a received message as a recorded data, and the history data is provided with a flag indicating that the history data has a recorded data; the telephone unit further comprising:
a recorded data presence determining unit for determining whether there exists the recorded data or not, and
a flag setting unit which sets the flag when said recorded data presence determining unit determined that there existed the recorded data.

14. A method of transmitting caller data received by telephone unit comprising the steps of:
determining whether a caller data is received or not, which data containing at least a caller's telephone number and incoming date and time;
storing a history data which contains at least said caller data;
updating said history data if there exists a history data of caller indicated in said caller data;
reading out said stored caller data and outputting said stored caller data to network interface unit;
receiving a reproduction command from outside; and
transmitting said updated history data to outside.

15. The transmitting method recited in claim 14, wherein
in said step of transmitting history data, either one of the entire history data stored in said memory and the new history data alone is transmitted.

16. The transmitting method recited in claim 14, further comprising
a step of providing a new history data if there is no history data of the caller indicated in said caller data.
